(19) United States
(12) Patent Application Publication
(10) Pub. No.: US 2003/0076811 A1
(43) Pub. Date: Apr. 24, 2003

(54) Method and device for wireless packet-switched communication

(76) Inventor: Anders Ruland, Malmo (SE)

Correspondence Address: Diane Dunn McKay, Mathews Collins Shepherd & Gould, Suite 306, 100 Thanet Circle, Princenton, NJ, 08540, US

(21) Appl. No.: 10/240,836

(22) PCT Filed: Apr. 5, 2001
(86) PCT No.: PCT/SE01/00756

(30) Foreign Application Priority Data
Apr. 5, 2000 (SE) 0001222-9

(51) Int. Cl. H04Q 7/00; H04J 3/24

(52) U.S. Cl. 370/349

(57) ABSTRACT

A method in a terminal, a packet switched wireless connection between the terminal and a server being established. A user program is executed in the server and transmits output data for indication at the terminal via the connection. Input data at the terminal are transferred for temporary indication at the terminal and are stored in a buffer. The terminal transmits a set of input data to the user program from the buffer via the connection at a predetermined size of the set of input data. Data incoming from the server are transferred for indication at the terminal while replacing temporarily indicated data.

### FIELD OF THE INVENTION

The invention relates to a method at a terminal. The term terminal relates to a computer that comprises an input member and an indicating member as well as at least one communication member for communication with an external computer. The terminal also comprises a control member for controlling other means.

The terminal communicates with an external computer, in which one or more user programs are executed. The user program is affected by input data from the input member of the terminal and transmits output data to the indicating member of the terminal.

### PRIOR ART

A terminal, or a so-called thin client, is today found in different embodiments. In one embodiment, a communication member is included for packet switched wireless communication, e.g. according to some of the systems GPRS (General Packet Radio Service), EDGE (Enhanced Data rates for Global Evolution) or UMTS (Universal Mobile Telecommunication System), with the external computer. The external computer is more powerful than the terminal and is configured, like a server, to execute application programs for other computers so-called clients.

In packet switched networks, e.g. GPRS, utility information is sent together with packing information and address information. The limited bandwidth which is available and a low ratio between utility information and other information which is transferred entails high costs for using a packet switched network in the applications in question.

Individual characters and altered movements with pointing devices and other corresponding input are converted by the terminal to digital data and are transferred in complete packets to the server. Data received by the server are transferred to the user program in question, which may result in the updating of information on a display device or the similar. This is being effected by transferring the corresponding data in complete packets from the server to the terminal via the wireless connection. A disadvantage is that the requisite complete packets contain relatively little utility information and are in that connection relatively expensive to transmit, since the cost is related to the total amount of data that is transferred. Another disadvantage is that display updates and the corresponding indication of the activities of the user of the terminal are delayed by the requisite communication.

For many applications, it would be desirable to increase the share of utility information that is transferred and thereby avoid that the costs for utilization of the communication systems becomes also high. It is also desirable to avoid the disadvantages that exist in the systems that are already in use.

### THE INVENTION IN SUMMARY

Therefore, an object of the invention is to provide a method where packet switched communication between a mobile computer, actually a terminal, and an external computer has a good efficiency.

The terminal has an input member, e.g. a keyboard, and an indicating member, e.g. a display. Furthermore, the terminal is provided with a communication member for the wireless connection with the external computer. On the other hand, the terminal may lack its own processor power as well as storing media for storing data and user programs. Naturally, the terminal comprises a processor or the similar for handling input and output data and a certain local data management.

An established active connection between the terminal and the server means that a user program is executed in the server. Output data from the program is transferred via the connection to the terminal and is made available for the user on the display. In the common way, the user controls and actuates the user program by inputting control data on the keyboard. Signals corresponding to these control data are indicated on an output member of the terminal without delay and are gathered in a buffer of the terminal. Only when the contents in the buffer are of a suitable size, the signals and the requisite packet information are transferred via the connection to the server. Data returning from the server replace the character information and other information that have been made available on the output member of the terminal.

In this way, the information exchange between server and terminal will take place more efficiently and at a lower cost.

### BRIEF DESCRIPTION OF THE DRAWINGS

The invention will now be described in more detail by means of embodiment examples while reference is made to the appended drawings, in which

FIG. 1 is a schematic block diagram of a terminal according to an embodiment of the invention and

FIG. 2 is a flow chart for the control of the terminal in FIG. 1.

### THE INVENTION

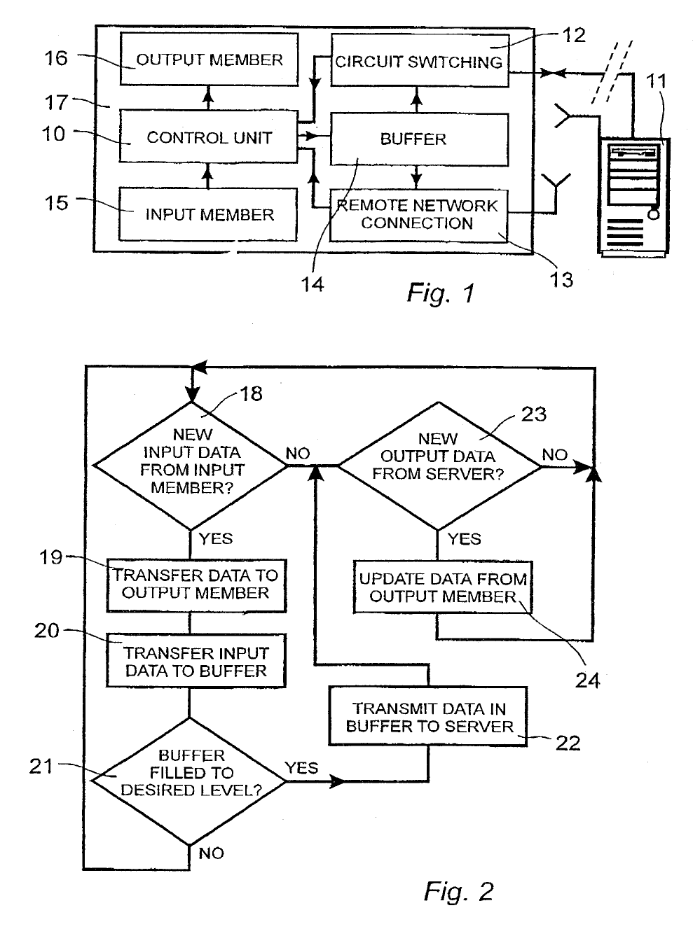

A schematic embodiment of a device according to the invention is shown in FIG. 1. The device in the form of a terminal 17, the outer shape of which may correspond to a conventional portable computer, comprises a control unit 10. The control unit 10 controls other units of the device. A plurality of different connection possibilities to an external computer 11 is included in the device. Below, the external computer 11 is denominated server. In the embodiment according to FIG. 1, a first connecting unit 12 is included in the form of a circuit switching unit for direct physical connection with the external computer 11. The circuit switching unit 12 may comprise a conventional network card or a similar hardware.

In the embodiment shown, also a second connecting unit 13 is included in the form of a communication member for wireless remote communication, e.g. GPRS. For the data transmission between the terminal and the server via primarily the second connecting unit 13, a buffer 14 is arranged at the terminal. Digital data, which correspond to information introduced to an input member 15, are transferred to the buffer 13 and not directly to a connecting unit and further to the server. The input member 15 may be a conventional keyboard, a touch screen or a similar device. An output member 16 is also included in the terminal for the indication of status and output signals from a user program executing in the server.

When a connection has been established between the device and the external computer 11, an input member or members 15 and an output member or members 16 of the device are used to start and then to control the execution of user programs of the external computer 11. A touch screen may also constitute part of the output member 16, which in other cases may comprise a conventional screen.

A control program executing in the control unit may comprise the functional steps that are shown in FIG. 2. It should be noted that the shown functional steps constitute a portion of the control program relevant for the invention, which program in addition comprises other and conventional portions for handling input and output data and for the indication of information on the output member.

A program cycle is continuously run-through. In a first step 18 in the cycle, it is checked if new input data are available at the input member 15. If this is the case, signals corresponding to these data are transferred to the output member 16 in a second step 19. Next, these input data are transferred to the buffer 14 in a third step 20.

In a fourth step 21, it is then checked if the buffer 14 is filled to the desired level. This level may be set and optimised depending on, e.g. total transfer need, application in question and channel capacity in question. If the desired level has been attained, data present in the buffer are sent in a fifth step 22 to the server 11 via the second connecting unit 13.

Next, in a sixth step 23, it is checked if new output data have arrived from the server 11. This sixth step is also reached if the control at the first step 18 results in that no new input data are available. If new output data are available, the information that is indicated on the output member 16 is updated in a seventh step 24. Then, the cycle returns to the first step 18 for a new control of input data from the input member.

The device according to the invention makes it possible for a user of a terminal without processor power of its own and without a set of user programs and data storing space of its own to continuously execute user programs in an external computer.

1. A method in a terminal, including the following steps: establishing a packet switched wireless connection between the terminal and a server, executing a user program in the server and transmitting output data via the connection from the user program for indication at the terminal, characterized by the following steps:
transferring input data of the terminal for temporary indication at the terminal and storing said data in a buffer,
transmitting from the terminal a set of input data to the user program from the buffer via the connection at a predetermined size of the set of input data, and
transferring incoming data from the server for indication at the terminal while replacing temporary indicated data.

2. A device in a terminal (17) having an input member (15) and an output member (16), wherein a control unit (10) is operatively connected to at least one connecting unit (12, 13) for wireless and packet switched connection with an external computer (11) and the control unit (10) is operatively connected to a buffer (14) for storage of input data transferred from the input member (15), characterized in
that the control unit (10) is operatively connected to the input member (15) for direct transfer of data put in to the output member (16) for temporary indication thereof,
that the control unit (10) is operatively connected to the output member (16) for indication of output data from an executing program in the external computer (11), and thereby replace temporarily indicated data of the output member (16) with corresponding data from the external computer (11), and
that the control unit (10) is designed to transmit a set of data of a predetermined size stored in the buffer (14) to the connecting unit (12, 13).
